(19) United States
(12) Patent Application Publication
(10) Pub. No.: US 2012/0198542 A1
(43) Pub. Date: Aug. 2, 2012

(54) Shared Security Device

(75) Inventors: Lap T. Huynh, Cary, NC (US); Constantinos Kassimis, Cary, NC (US); Jeffrey A. Lucovsky, Cary, NC (US); Linwood H. Overby, JR., Raleigh, NC (US); Jerry W. Stevens, Raleigh, NC (US)

(73) Assignee: International Business Machines Corporation, Armonk, NY (US)

(21) Appl. No.: 13/423,788

(22) Filed: Mar. 19, 2012

Related U.S. Application Data
(63) Continuation of application No. 12/624,762, filed on Nov. 24, 2009.

(51) Int. Cl. G06F 21/00; G06F 15/16

(52) U.S. Cl. 726/13

(57) ABSTRACT

A mechanism is provided for sharing one or more security appliances. A trusted system component associated with an application of a plurality of applications in a logically partitioned data processing system sets a destination address of a received packet to an address of a security appliance shared by the plurality of applications. The trusted system component sends the received packet to the security appliance. The trusted system component receives a response from the security appliance. The trusted system component determines whether the response indicates permitting the received packet to proceed to the intended recipient. The trusted system component sends the received packet to the recipient in response to the response indicating permitting the received packet to proceed.

### BACKGROUND

The present application relates generally to an improved data processing apparatus and method and more specifically to an apparatus and method for sharing a security device between multiple servers and/or security tiers within a virtualized server environment.

Today, devices that perform security functions, which require access to each packet in a flow or connection, are deployed externally in a network with respect to host endpoints that generate and receive the packets. Examples of such security devices are devices that perform packet inspection for intrusion prevention services, data leak protection, etc. These security devices are typically deployed in the network using a physical configuration at a switching layer in order to gain access to the data traffic flowing across the network segment and many times are not part of the visible layer 3 network topology. Security devices are deployed in close proximity to the network that is being protected and/or monitored. Typically, security devices are placed at security tier boundaries or in front of specific servers or server groups. In order to provide service to multiple security tiers, multiple security devices are typically deployed.

As multiple servers are consolidated in order save energy cost, floor space, and reduce server cost, servers and network functionality are combined within a physical server environment. In this environment, a mix of server types and security tiers may co-exist. In this environment, servers are virtualized and run on shared hardware. As server costs decrease it is necessary to reduce the costs of security device functionality on a per server basis. However, mapping security device functionality onto virtual images may be problematic for several reasons, such as:
a. Performance—Security device function may be CPU intensive and is often run on specialized security appliances or hardware; or
b. Traffic interception—Networks in the consolidated environment are virtualized and isolated logically, thus, they may be highly dynamic and do not easily allow for insertion of physical security devices.

### SUMMARY

In one illustrative embodiment, a method, in a data processing system; is provided for sharing one or more security appliances. The illustrative embodiment sets a destination address of a received packet to an address of a security appliance shared by the plurality of applications. The illustrative embodiment sends the received packet to the security appliance. The illustrative embodiment receives a response from the security appliance. The illustrative embodiment determines whether the response indicates permitting the received packet to proceed to the intended recipient. Responsive to the response indicating permitting the received packet to proceed, the illustrative embodiment sends the received packet to the recipient.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a block diagram of a data processing system with which aspects of the illustrative embodiments may advantageously be utilized;

FIG. 2 depicts a block diagram of an exemplary logically partitioned platform in which the illustrative embodiments may be implemented;

FIG. 3 depicts an exemplary implementation of shared security devices in a virtualized server environment in accordance with an illustrative embodiment;

FIG. 4 depicts a flowchart outlining an example operation of a trusted system component operating with shared security devices in a virtualized server environment in accordance with an illustrative embodiment; and

FIG. 5 depicts a flowchart outlining an example operation of a trusted system component receiving a response from shared security devices in a virtualized server environment in accordance with an illustrative embodiment.

### DETAILED DESCRIPTION

The illustrative embodiments provide a mechanism that allows trusted system components (TSCs) to intercept traffic and direct the traffic to specialized security hardware that is optimized for security processing. The mechanism allows for the return of the traffic to a trusted system component after security processing. The security hardware may be security-tier independent and may be viewed as a shareable system resource across multiple servers, networks, and security tiers. The mechanism allows for individual systems in a virtualized environment to optionally select security software implemented in software on general purpose processors using the same interception methods as security appliance hardware, allowing a mix of software security and specialized security appliance processing.

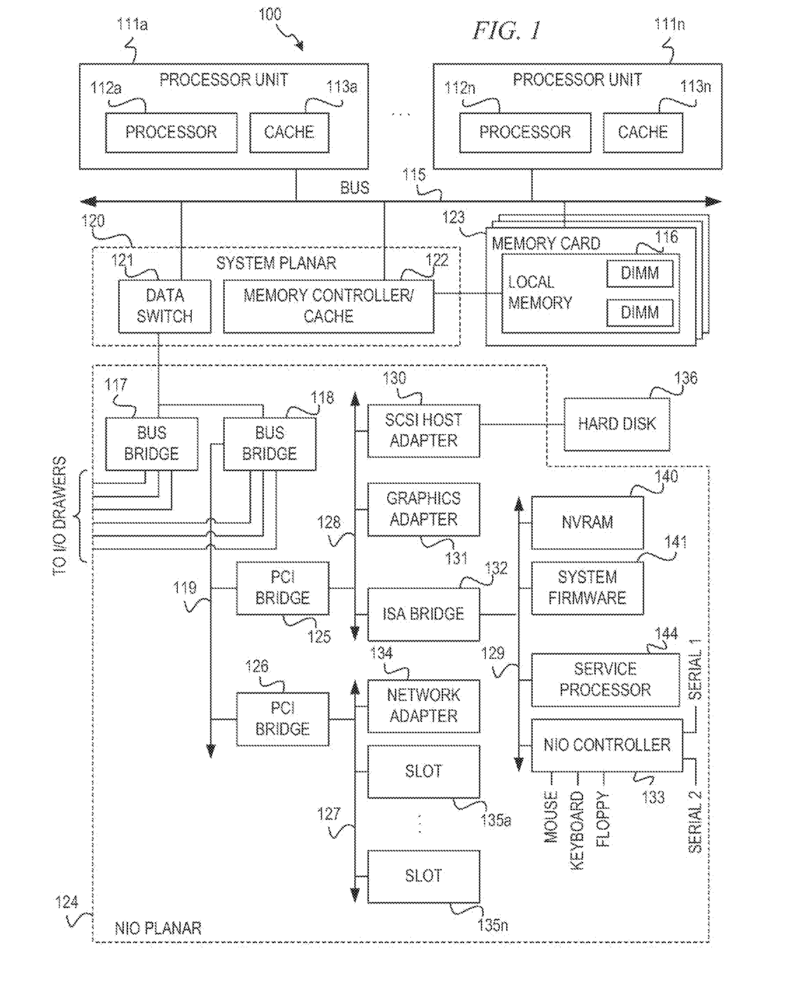

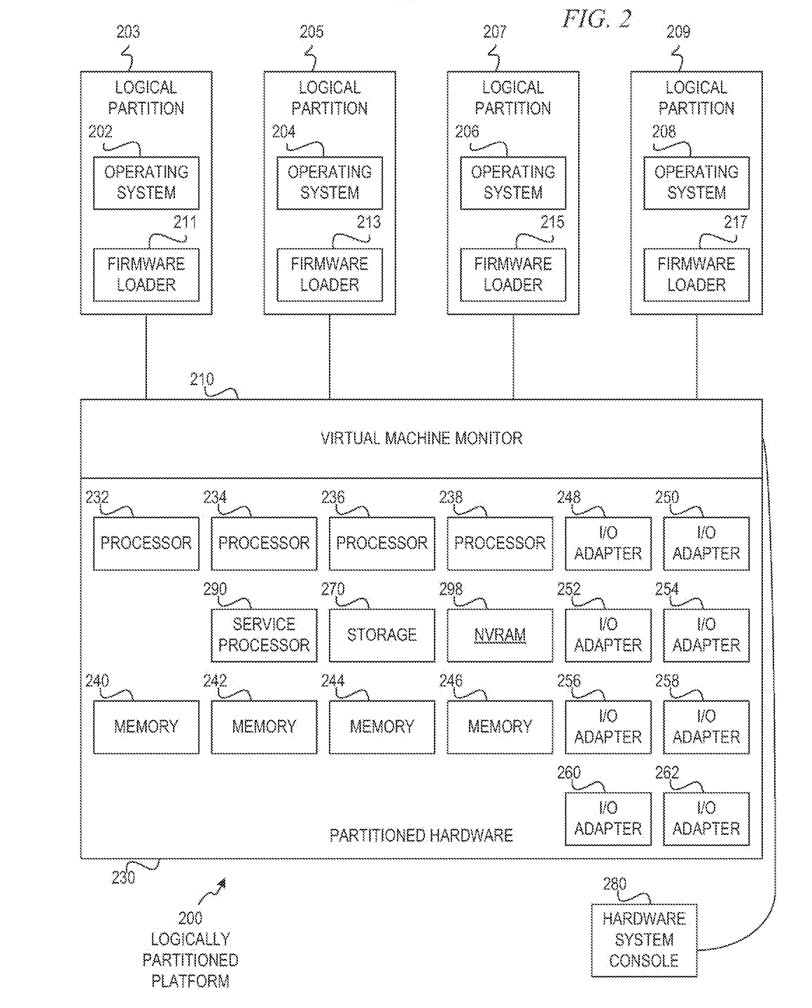

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on a single data processing device implementation of a security device shared between multiple servers and/or security tiers within a virtualized server environment, this is only an example and is not intended to state or imply any limitation with regard to the features of the present invention. To the contrary, the illustrative embodiments are intended to include distributed data processing environments and embodiments in which a security device may be shared between multiple servers and/or security tiers within a virtualized server environment.

With reference now to the figures and in particular with reference to FIGS. 1-2, example diagrams of data processing environments are provided in which illustrative embodiments of the present invention may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

In the illustrative embodiments, a computer architecture is implemented as a combination of hardware and software. The software part of the computer architecture may be referred to as microcode or millicode. The combination of hardware and software creates an instruction set and system architecture that the rest of the computer's software operates on, such as Basic Input/Output System (BIOS), Virtual Machine Monitors (VMM), Hypervisors, applications, etc. The computer architecture created by the initial combination is immutable to the computer software (BIOS, etc), except through defined interfaces which may be few.

Referring now to the drawings and in particular to FIG. 1, there is depicted a block diagram of a data processing system with which aspects of the illustrative embodiments may advantageously be utilized. As shown, data processing system 100 includes processor units 111a-111n. Each of processor units 111a-111n includes a processor and a cache memory. For example, processor unit 111a contains processor 112a and cache memory 113a, and processor unit 111n contains processor 112n and cache memory 113n.

Processor units 111a-111n are connected to main bus 115. Main bus 115 supports system planar 120 that contains processor units 111a-111n and memory cards 123. System planar 120 also contains data switch 121 and memory controller/cache 122. Memory controller/cache 122 supports memory cards 123 that include local memory 116 having multiple dual in-line memory modules (DIMMs).

Data switch 121 connects to bus bridge 117 and bus bridge 118 located within native I/O (NIO) planar 124. As shown, bus bridge 118 connects to peripheral components interconnect (PCI) bridges 125 and 126 via system bus 119. PCI bridge 125 connects to a variety of I/O devices via PCI bus 128. As shown, hard disk 136 may be connected to PCI bus 128 via small computer system interface (SCSI) host adapter 130. Graphics adapter 131 may be directly or indirectly connected to PCI bus 128. PCI bridge 126 provides connections for external data streams through network adapter 134 and adapter card slots 135a-135n via PCI bus 127.

Industry standard architecture (ISA) bus 129 connects to PCI bus 128 via ISA bridge 132. ISA bridge 132 provides interconnection capabilities through NIO controller 133 having serial connections Serial 1 and Serial 2. A floppy drive connection, keyboard connection, and mouse connection are provided by NIO controller 133 to allow data processing system 100 to accept data input from a user via a corresponding input device. In addition, non-volatile RAM (NVRAM) 140, connected to ISA bus 129, provides a non-volatile memory for preserving certain types of data from system disruptions or system failures, such as power supply problems. System firmware 141 is also connected to ISA bus 129 for implementing the initial Basic Input/Output System (BIOS) functions. Service processor 144 connects to ISA bus 129 to provide functionality for system diagnostics or system servicing.

The operating system (OS) is stored on hard disk 136, which may also provide storage for additional application software for execution by a data processing system. NVRAM 140 is used to store system variables and error information for field replaceable unit (FRU) isolation. During system startup, the bootstrap program loads the operating system and initiates execution of the operating system. To load the operating system, the bootstrap program first locates an operating system kernel image on hard disk 136, loads the OS kernel image into memory, and jumps to an initial address provided by the operating system kernel. Typically, the operating system is loaded into random-access memory (RAM) within the data processing system. Once loaded and initialized, the operating system controls the execution of programs and may provide services such as resource allocation, scheduling, input/output control, and data management.

The illustrative embodiment may be embodied in a variety of data processing systems utilizing a number of different hardware configurations and software such as bootstrap programs and operating systems. The data processing system 100 may be, for example, a stand-alone system or part of a network such as a local-area network (LAN) or a wide-area network (WAN). As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary logically partitioned platform is depicted in which the illustrative embodiments may be implemented. The hardware in logically partitioned platform 200 may be implemented, for example, using the hardware of data processing system 100 in FIG. 1.

Logically partitioned platform 200 includes partitioned hardware 230, operating systems 202, 204, 206, 208, and virtual machine monitor 210. Operating systems 202, 204, 206, and 208 may be multiple copies of a single operating system or multiple heterogeneous operating systems simultaneously run on logically partitioned platform 200. These operating systems may be implemented, for example, using z/OS, which is designed to interface with a virtualization mechanism, such as partition management firmware, e.g., a hypervisor. z/OS is used only as an example in these illustrative embodiments. Of course, other types of operating systems, such as OS/400, AIX®, and Linux®, may be used depending on the particular implementation. Operating systems 202, 204, 206, and 208 are located in logical partitions 203, 205, 207, and 209, respectively.

Hypervisor software is an example of software that may be used to implement platform (in this example, virtual machine monitor 210) and is available from International Business Machines Corporation. Firmware is “software” stored in a memory chip that holds its content without electrical power, such as, for example, a read-only memory (ROM), a programmable ROM (PROM), an erasable programmable ROM (EPROM), and an electrically erasable programmable ROM (EEPROM).

Logical partitions 203, 205, 207, and 209 also include partition firmware loader 211, 213, 215, and 217. Partition firmware loader 211, 213, 215, and 217 may be implemented using IPL or initial boot strap code, IEEE-1275 Standard Open Firmware, and runtime abstraction software (RTAS), which is available from International Business Machines Corporation.

When logical partitions 203, 205, 207, and 209 are instantiated, a copy of the boot strap code is loaded into logical partitions 203, 205, 207, and 209 by virtual machine monitor 210. Thereafter, control is transferred to the boot strap code with the boot strap code then loading the open firmware and RTAS. The processors associated or assigned to logical partitions 203, 205, 207, and 209 are then dispatched to the logical partition's memory to execute the logical partition firmware.

Partitioned hardware 230 includes a plurality of processors 232-238, a plurality of system memory units 240-246, a plurality of input/output (I/O) adapters 248-262, and storage unit 270. Each of the processors 232-238, memory units 240-246, NVRAM storage 298, and I/O adapters 248-262 may be assigned to one of multiple logical partitions 203, 205, 207, and 209 within logically partitioned platform 200, each of which corresponds to one of operating systems 202, 204, 206, and 208.

Virtual machine monitor 210 performs a number of functions and services for logical partitions 203, 205, 207, and 209 to generate and enforce the partitioning of logical partitioned platform 200. Virtual machine monitor 210 is a firmware implemented virtual machine identical to the underlying hardware. Thus, virtual machine monitor 210 allows the simultaneous execution of independent OS images 202, 204, 206, and 208 by virtualizing all the hardware resources of logical partitioned platform 200.

Service processor 290 may be used to provide various services, such as processing of platform errors in logical partitions 203, 205, 207, and 209. Service processor 290 may also act as a service agent to report errors back to a vendor, such as International Business Machines Corporation. Operations of the different logical partitions may be controlled through a hardware system console 280. Hardware system console 280 is a separate data processing system from which a system administrator may perform various functions including reallocation of resources to different logical partitions.

Again, the illustrative embodiments provide a mechanism that allows trusted system components to intercept traffic (i.e. packets) and direct the traffic to specialized security hardware, which may be referred to as security appliances, that is optimized for security processing and allows for the return of the traffic to a trusted system component after security processing. The following description is presented in terms of a typical virtualized server environment where applications are being hosted by application server blades and traditional computing hardware both on native operating systems and virtualized operating systems. However, those of ordinary skill in the art will appreciate that the hardware in the following Figures may vary depending on the implementation, without departing from the spirit and scope of the present invention.

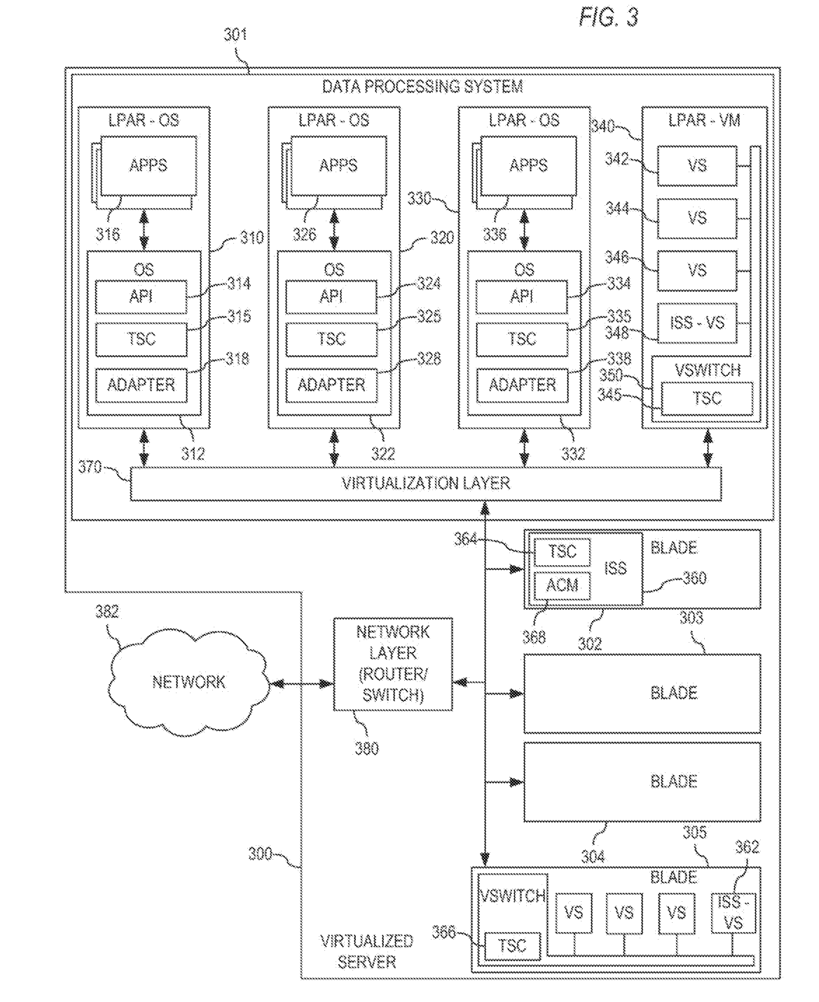

FIG. 3 depicts an exemplary implementation of shared security devices in a virtualized server environment in accordance with an illustrative embodiment. Virtualized server environment 300 is depicted as a blade center comprising blades or blade module 301, 302, 303, 304, and 305. In this example, blade module 301 is implemented as a logically partitioned data processing system. The logically partitioned data processing system has a plurality of logical partitions (LPARs) 310, 320, 330, which may also be referred to as clients or initiators. LPAR 310 has an instance of an operating system 312 with a set of application programming interfaces (APIs) 314 and one or more applications 316 running. LPAR 320 has operating system 322 with APIs 324 and one or more applications 326. LPAR 330 has operating system 332 with APIs 334 and one or more applications 336. While virtualized server environment 300 illustrates only LPARs 310, 320, and 330, the illustrative embodiments are not limited to such. Rather, any number of LPARs may be utilized with the mechanisms of the illustrative embodiments without departing from the spirit and scope of the present invention. For example, LPAR 340 is a virtual machine logical partition which one or more instances of virtual systems 342, 344, 346, and 348 instantiated thereon. LPAR 340 also comprises virtual switch 350 which provides core layer forwarding, virtual local area network (VLAN) tagging, stripping, and filtering, layer security, checksum, and segmentation offload, or the like. While not depicted in FIG. 3, one or more of LPARs 310, 320, or 330 may also be configured to function as a separate internet security system (ISS) appliance or part of an ISS appliance cluster without departing from the spirit and scope of the invention.

LPARs 310, 320, 330, and 340 may communicate with one another as well as with other operating systems, virtualized systems, appliances, appliance clusters, or the like, through virtualization layer 370. Virtualization layer 370 is software that performs communications and resource management to allow multiple instances of operating systems 312, 322, and 332 and virtual systems 342, 344, 346, and 348 to run on virtualized server environment 300 at the same time. Virtualization layer 370 performs tasks such as processor time slice sharing, memory allocation, or the like. Virtualization layer 370 may be, for example, a hypervisor.

While the illustrative embodiments depict one implementation of the security appliance being implemented as ISS-VS 348 on LPAR 340, the security appliance accessed by TSCs 315, 325, and 335, may also be implemented and accessed on other blades within virtualized server environment 300, such as internet security system (ISS) 360 being implemented as a security appliance cluster on blade 302 or as ISS-VS 362 as one of a number of virtual systems on a shared appliance cluster of blade 305. A security appliance cluster, such as ISS 360, may be managed by an appliance cluster manager 368.

In addition to the above described elements, each of LPARs 310, 320, 330, and 340 as well as ISS 360 and ISS-VS 362 comprise intercept points or trusted system components (TSCs) 315, 325, 335, 345, 364, and 366, respectively. TSCs 315, 325, 335, 345, 364, and 366, built into various layers of the system that are authenticated and under system control, are a “hook point”, in normal packet processing, that diverts traffic to a security appliance or process, such as ISS-VS 348, ISS 360, or ISS-VS 362. TSCs 315, 325, 335, 345, 364, and 366 may be implemented in various layers of the system that are authenticated and under system control. For example, a TSC may be implemented in a device, driver, or Internet protocol (IP) layer of a trusted system operating system. If the operating system, such as operating systems 312, 322, or 332, is loaded into a virtual machine, the TSC may be implemented in virtualization layer 370 rather than into the guest operating system. A TSC may also be implemented in an IP router as a first line of defense before traffic enters the computing domain.

Each of the depicted security appliances or appliance clusters, ISS-VS 348, ISS 360, or ISS-VS 362 may be addressable either by layer 2 (MAC addresses) or layer 3 (IP addresses). Therefore, each of TSCs 315, 325, 335, 345, 364, and 366 are also addressable by layer 2 (MAC addresses) or layer 3 (IP addresses). While not depicted in FIG. 3, ISS-VS 348, ISS 360, or ISS-VS-362 may be accessed as Web services where a TSC is integrated into middleware/application and where traffic is redirected to ISS-VS 348, ISS 360, or ISS-VS 362 via the Internet before processing. That is, virtualized server environment 300 may represent web services comprising ISS and TSC components that are accessible via the Internet without departing from the spirit and scope of the invention. TSCs 315, 325, 335, 345, 364, and 366 utilize a separate MAC or IP address to represent directionality with respect to the calling system for both inbound and outbound traffic. TSCs 315, 325, and 335 may receive outbound packets from applications, 316, 326, or 336, or inbound packets from an external application via network 382 and network layer 380, which may be implemented as a router or a switch. When TSC 315, 325, 335, 345, 364, or 366 receive a packet that needs to be verified by security appliance or appliance cluster 348, 360, or 362, TSC 315, 325, 335, 345, 364, or 366 may either set the destination address in the packet to the address of the desired one of security appliance or appliance cluster 348, 360, or 362 or hold the originally received packet and set the destination address in a copy of the original packet to the address of the desired one of security appliance or appliance cluster 348, 360, or 362. The source address is set to either the inbound or the outbound server address, depending on traffic directionality. Security appliance or appliance cluster 348, 360, or 362 then processes the packet received from TSC 315, 325, 335, 345, 364, or 366.

If after security processing the packet is approved or permitted to proceed, security appliance or appliance cluster 348, 360, or 362 may either, if the original packet was sent, reverse the source and destination addresses in order to return the packet to the requesting one of TSC 315, 325, 335, 345, 364, or 366 or send a packet disposition signal or, if the packet was held at the TSC, send a “packet disposition signal” to TSC 315, 325, 335, 345, 364, or 366. That is, if after security processing the packet fails processing or is denied further processing, security appliance or appliance cluster 348, 360, or 362 may discard the packet and send a packet disposition signal to TSC 315, 325, 335, 345, 364, or 366 or, if the packet was held at the TSC, security appliance or appliance cluster 348, 360, or 362 may send a “packet disposition signal” to TSC 315, 325, 335, 345, 364, or 366 for the TSC to discard the packet. When the packet is returned to TSCs 315, 325, 335, 345, 364, or 366 by either security appliance or appliance cluster 348, 360, or 362, TSC 315, 325, 335, 345, 364, or 366 may determine whether the traffic was originally inbound or outbound based on the destination address in the returning packet. If the TSC is implemented in virtualization layer 370 or it is otherwise undesirable to alter the original addressing structure of the packet, TSC 315, 325, or 335 may encapsulate the original packet with the address of the desired one of security appliance or appliance cluster 348, 360, or 362. Whether TSCs 315, 325, 335, 345, 364, or 366 receive a packet or packet disposition signal, TSCs 315, 325, 335, 345, 364, or 366 may log the final disposition of all packets either inbound or outbound. All security appliances and TSCs may be configured to be on a single virtual LAN (VLAN) used for all traffic sent between TSCs and security appliances so that the security appliance is not required to be a member of all VLANs in the virtualized set of servers. Using a separate VLAN also allows traffic be differentiated and isolated from other traffic.

TSCs 315, 325, 335, 345, 364, and 366 may be configured to communicate with a single security appliance address, multiple available security appliance addresses, or the address of an appliance cluster manager which can optionally load balance across the set of security appliances. If there are multiple security appliances available, such as the case of security appliance cluster 360, TSCs 315, 325, 335, 345, 364, and 366 may optionally load balance the requests over the set of security appliances in security appliance cluster 360. TSCs 315, 325, 335, 345, 364, and 366 may load balance using either a round-robin technique, algorithmically based on IP addresses, protocols, and ports, based on capacity of the appliance, or the like. If appliance cluster manager 368 load balances based on capacity, the security appliances may periodically send capacity data to the appliance cluster manager. TSCs 315, 325, 335, 345, 364, and 366 may also perform load balancing based on capacity information versus static IP address or port algorithms, which can yield more optimal workload balancing while allowing security appliance or appliance cluster 348, 360, or 362 to maintain any connection oriented state information.

Additionally, TSCs 315, 325, 335, 345, 364, and 366 may perform performance optimization by pushing load-balancing decisions, such as tables, arrays, register entries, or the like, into storage accessible by TSCs 315, 325, 335, 345, 364, and 366 so that subsequent inbound packets processed after the security appliance assignment has been made may be routed to the security appliance from the device driver layer without requiring processing by higher layers of the networking stack.

This invention allows TSCs 315, 325, 335, 345, 364, and 366 and security appliances and appliance cluster 348, 360, and 362 to cooperatively reduce the number of packets sent to security appliance or appliance cluster 348, 360, or 362 with a signaling protocol between security appliances or appliance cluster 348, 360, and 362 and TSCs 315, 325, 335, 345, 364, and 366 as follows:
a. Future interest by security appliance or appliance cluster 348, 360, or 362 in subsequent packet may be based on various criteria. For example, current connection, future connections for the server application and/or system, or client application and/or system.
b. An “already processed” signal may be sent by security appliance or appliance cluster 348, 360, or 362 to TSC 315, 325, or 335 if the security appliance or appliance cluster 348, 360, or 362 detects that another one of TSC 315, 325, or 335 is sending the same data for the same connection to security appliance or appliance cluster 348, 360, or 362. TSC 315, 325, or 335 may optionally react by not sending subsequent packets for that connection to security appliance or appliance cluster 348, 360, or 362.
c. If TSC 315, 325, or 335 “holds” a packet, security appliance or appliance cluster 348, 360, or 362 may send a “packet disposition signal” to TSC 315, 325, or 335, rather than returning the original packet. A disposition indicator may include permit, discard, log, or the like. Greater efficiency may be achieved if security appliance or appliance cluster 348, 360, or 362 bundles the disposition indicator for multiple held packets in a same signal. One note is that without this signaling method, TSCs 315, 325, and 335 will not hold packets that are sent out for evaluation.

in the case of network congestion or security appliance or appliance cluster 348, 360, or 362 being overloaded, TSCs 315, 325, and 335 may selectively direct packets of critical workloads to security appliance or appliance cluster 348, 360, or 362 for inspection and discard other less critical packets. Configuration at TSCs 315, 325, and 335 may also be used to reduce the number of packets sent to security appliance or appliance cluster 348, 360, or 362. This configuration may be simply a global definition to divert all traffic to security appliance or appliance cluster 348, 360, or 362 or may be more granular with one or more conditions filters that specify the traffic that should be diverted to security appliance, or appliance cluster 348, 360, or 362. Conditions filters may include various combinations of selectors such as IP addresses, protocols, ports, local link used, or the like.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for, use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

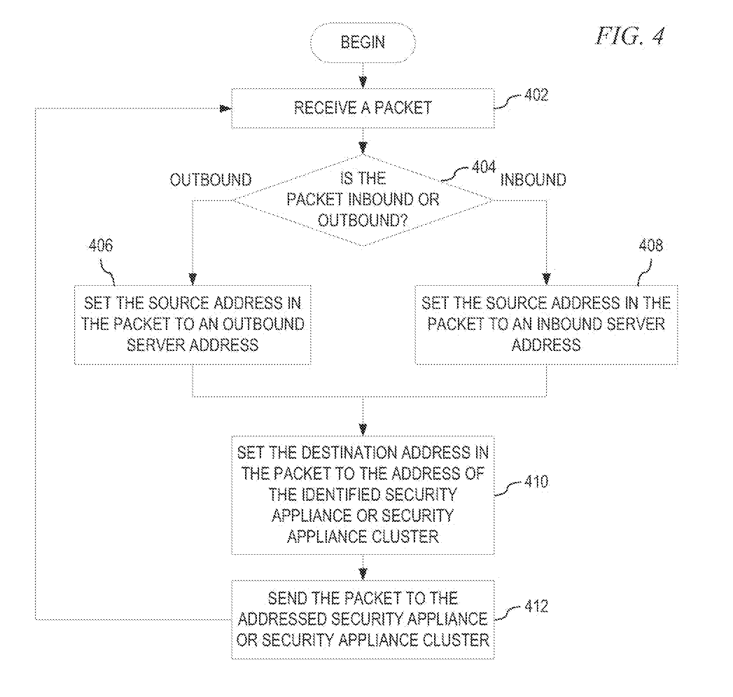

Referring now to FIG. 4, this figure provides a flowchart outlining the example operation of a trusted system component operating with shared security devices in a virtualized server environment in accordance with an illustrative embodiment. As the operation begins, the trusted system component (TSC) receives a packet from a local data processing system application, a network application, or the like directed to a recipient (step 402). The TSC determines whether the packet is an outbound packet or an inbound packet (step 404). Vat step 404 the packet is outbound, then the TSC sets the source address in the packet to an outbound server address, if the original packet is to be sent to security appliance or security appliance cluster, or generates a copy of the packet and sets the source address in the copied packet to the outbound server address, if the original packet is to be held in the TSC (step 406). If at step 404 the packet is inbound, then the TSC sets the source address in the packet to an inbound server address, if the original packet is to be sent to security appliance or security appliance cluster, or generates a copy of the packet and sets the source address in the copied packet to the inbound server address, lithe original packet is to be held in the TSC (step 408).

From steps 406 or 408, the TSC sets the destination address in the packet or the copied packet to the address of the identified security appliance or security appliance cluster (step 410). The TSC then sends the packet to the addressed security appliance or security appliance cluster (step 412), with the operation returning to step 402 thereafter.

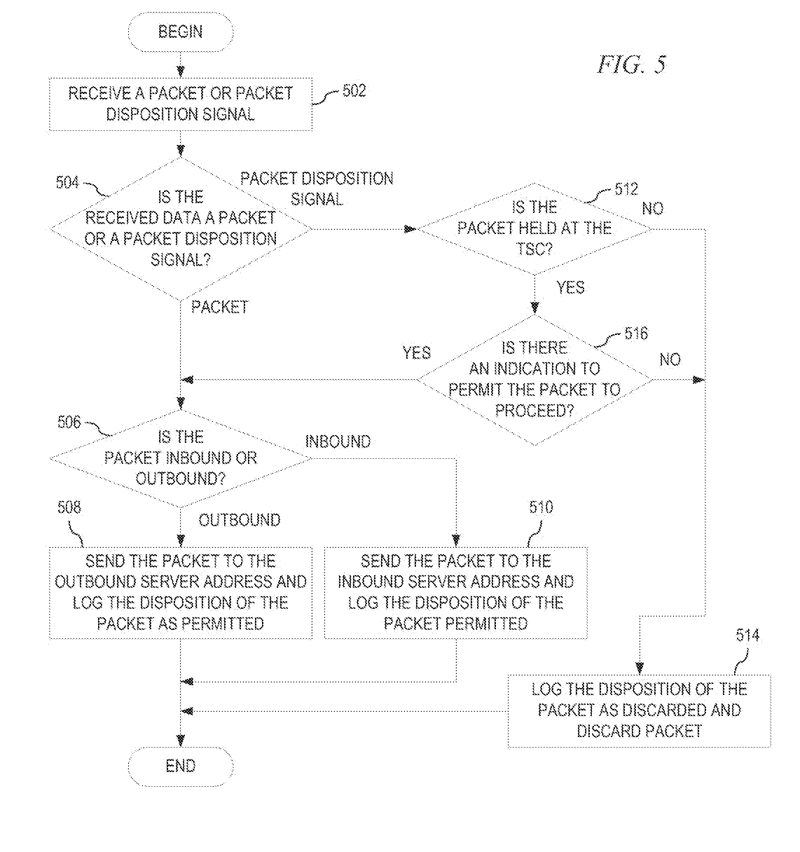

Referring now to FIG. 5, this figure provides a flowchart outlining the example operation of a trusted system component receiving a response from shared security devices in a virtualized server environment in accordance with an illustrative embodiment. As the operation begins, the trusted system component (TSC) receives a packet or a packet disposition signal from a security appliance or a security appliance cluster, or the like (step 502). Since an original packet may be held at the TSC or sent to the security appliance or the security appliance cluster for security processing, the security appliance or the security appliance cluster may either respond with the original packet including an indication of how to process the packet, a packet disposition signal stating how the packet was processed by the security appliance or the security appliance cluster, or a packet disposition signal stating how the TSC needs to process the held packet.

That is, if the security processing performed by the security appliance or the security appliance cluster determines that the packet contains malicious data, the security appliance or the security appliance cluster will automatically discard the original packet and respond to the TSC with a packet disposition signal. Therefore, if the TSC sends the original packet to the security appliance or the security appliance cluster, then the TSC should only expect the original packet back with an indication to permit the packet to proceed onto the recipient. However, if the TSC holds the packet and sends a copied packet to the security appliance or the security appliance cluster, then the security appliance or the security appliance cluster may respond with a packet disposition signal that indicates that the TSC either permit the packet or discard the packet.

Thus, the TSC determines whether a packet or a packet dispositions signal is received (step 504). If at step 504 a packet is received from the security appliance or the security appliance cluster, then the TSC determines whether the packet was inbound or outbound based on the source address of the packet (step 506). If at step 506 the source address indicates an outbound server address, then the TSC sends the packet to the outbound server address of the recipient and logs the disposition of the packet (step 508), with the operation terminating thereafter. If at step 506 the source address indicates an inbound server address, then the TSC sends the packet to the inbound server address of the recipient and logs the disposition of the packet (step 510), with the operation terminating thereafter.

If at step 504 a packet disposition signal is received from the security appliance or the security appliance cluster, then the TSC determines whether the packet was held at the TSC (step 512). If at step 512 the packet was not held at the TSC, then the TSC logs the disposition of the packet as being discarded (step 514), with the operation terminating thereafter. If at step 512 the packet was being held at the TSC, then the TSC determines whether the packet disposition signal indicates to permit the packet to proceed (step 516). If at step 516 the packet disposition signal indicates that the packet should proceed, then the operation proceeds to step 506. If at step 516 the packet disposition signal indicates that the packet should be discarded and the TSC discards the packet, then operation proceeds to step 514.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide a mechanism that allows trusted system components to intercept traffic and direct the traffic to specialized security hardware that is optimized for security processing. The mechanism allows for the return of the traffic to trusted system component after security processing. The security hardware may be security-tier independent and may be viewed as a shareable system resource across multiple servers, networks, and security tiers. The mechanism allows for individual systems in a virtualized environment to optionally select security software implemented in software on general purpose processors using the same interception methods as security appliance hardware, allowing a mix of software security and specialized security appliance processing.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program, code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a logically partitioned data processing system, for sharing one or more security appliances, the method comprising:
setting, by a trusted system component associated with an application of a plurality of applications in the logically partitioned data processing system, a destination address of a received packet to an address of a security appliance shared by the plurality of applications;
sending, by the trusted system component, the received packet to the security appliance;
receiving, by the trusted system component, a response from the security appliance;
determining, by the trusted system component, whether the response indicates permitting the received packet to proceed to the intended recipient; and
responsive to the response indicating permitting the received packet to proceed, sending, by the trusted system component, the received packet to the recipient.

2. The method of claim 1, further comprising:
responsive to the response indicating discarding the received packet, discarding, by the trusted system component, the received packet.

3. The method of claim 1, further comprising:
determining, by the trusted system component, whether the received packet is inbound to the application or outbound from the application;
responsive to the received packet being outbound, setting, by the trusted system component, the source address in the received packet to an outbound server address; and
responsive to the received packet being inbound, setting, by the trusted system component, the source address in the received packet to an inbound server address.

4. The method of claim 1, further comprising:
generating, by a trusted system component, a copy of the received packet thereby forming a copied packet;
holding, by a trusted system component, the received packet in a storage associated with the trusted system component;
setting, by a trusted system component, a destination address of a copied packet to the address of the security appliance shared by the plurality of applications; and
sending, by the trusted system component, the copied packet to the security appliance instead of the received packet.

5. The method of claim 4, further comprising:
determining, by the trusted system component, whether the copied packet is inbound to the application or outbound from the application;
responsive to the received packet being outbound, setting, by the trusted system component, the source address in the copied packet to an outbound server address; and
responsive to the received packet being inbound, setting, by the trusted system component, the source address in the copied packet to an inbound server address.

6. The method of claim 1, wherein the plurality of applications are operating in two or more logical partitions on the logically partitioned data processing system.

7. The method of claim 1, wherein the security appliance is instantiated as at least one virtual machine on a virtual machine logical partition, a logical partition functioning as a internet security system appliance, one of a plurality of security appliances on a security appliance cluster, or one virtual system of a plurality of virtual systems on a shared appliance cluster.

8. The method of claim 1, further comprising:
logging, by the trusted system component, a disposition of the received packet.

9. The method of claim 1, wherein the security appliance and the trusted system component are configured on a separate virtual network used for all traffic sent between the trusted system component and the security appliance, so that the separate virtual network is isolated and differentiated from other traffic.

10. The method of claim 1, wherein the logically partitioned data processing system comprises a plurality of security appliances and where the trusted system component sends a plurality of received packets to the plurality of security appliances using load balancing based on capacity information of each of the plurality of security appliances.

11-20. (canceled)
